(19) United States
(12) Patent Application Publication
(10) Pub. No.: US 2014/0113183 A1
(43) Pub. Date: Apr. 24, 2014

(54) LITHIUM-ION BATTERY WITH SAFETY PROTECTION BRACKET

(71) Applicant: NingDe Contemporary Amperex Technology Limited, Ningde City (CN)

(72) Inventors: Quankun Li, Ningde City (CN); Pinghua Deng, Ningde City (CN); Peng Wang, Ningde City (CN); Kai Wu, Ningde City (CN); Heng Zhang, Ningde City (CN)

(73) Assignee: NingDe Contemporary Amperex Technology Limited, Ningde City (CN)

(21) Appl. No.: 14/055,217

(22) Filed: Oct. 16, 2013

(30) Foreign Application Priority Data
Oct. 19, 2012 (CN) 201220535684.1

(51) Int. Cl. H01M 10/42

(52) U.S. Cl. CPC H01M 10/4235
USPC 429/178; 429/163

(57) ABSTRACT

A lithium-ion battery includes a safety protection bracket. The battery includes an electrode assembly and an aluminum housing for receiving the electrode assembly, wherein the electrode assembly comprises a cathode, an anode, and a separator film, a cathode tab is positioned on the cathode, an anode tab is positioned on the anode, a safety bracket is positioned on the top of the electrode assembly, and the safety bracket is located between the aluminum housing and the electrode assembly, and an aluminum top cover fixedly connected to the aluminum housing is positioned on the aluminum housing. The battery provides a safety protection unit deployed on the bracket can fix the electrode assembly, and in addition, when the battery is punctured or crushed or otherwise misused, release energy of a faulty cell through an outer short-circuit to avoid greater accidents and ensure safety performance of the battery.

### TECHNICAL FIELD OF THE INVENTION

This invention relates to lithium-ion battery technologies, and in particular, to a lithium-ion battery with a safety protection bracket.

### BACKGROUND OF THE INVENTION

In the prior art, since success of developing a lithium-ion battery, the lithium-ion battery has been applied more and more widely in electronic devices in recent years due to its advantages such as high working capacity, high output power, wide range of working temperatures, low self-discharge rate, long cycle life, safety, environmental protection, and no pollution, and has become a standard configuration of electronic devices such as mobile phones.

However, in recent years, lithium-ion batteries tend to catch fire, explode or even cause injuries when being used improperly, such as being heated, overcharged, over-discharged, short-circuited, vibrated, or crushed. Therefore, the safety of lithium-ion batteries arouses wide concern of people.

When a lithium-ion battery is punctured or crushed or otherwise misused, a short circuit occurs inside the battery, and the battery temperature rises. When the temperature rises to a certain extent, thermal runaway occurs in the battery, which may cause a fire or explosion and lead to safety problems.

### SUMMARY OF THE INVENTION

To overcome defects of the prior art, this invention aims to provide a lithium-ion battery with a safety protection bracket, which can fix an electrode assembly and release energy of a faulty cell through an outer short-circuit to ensure safety performance of the battery.

To fulfill such objectives, this invention discloses a lithium-ion battery with a safety protection bracket, where the battery includes an electrode assembly and an aluminum housing for receiving the electrode assembly, where the electrode assembly includes a cathode , an anode, and a separator film; a cathode tab is positioned on the cathode , an anode tab is positioned on the anode, a safety bracket is positioned on the top of the electrode assembly, and the safety bracket is located between the aluminum housing and the electrode assembly, and an aluminum top cover fixedly connected to the aluminum housing is positioned on the aluminum housing. The safety bracket positioned in the lithium-ion battery can fix the electrode assembly, and in addition, the safety bracket and the lithium-ion battery form an outer short-circuit to release energy of a faulty cell and ensure safety performance of the battery when the battery is punctured or crushed or otherwise misused.

As a further improvement of the invention, the aluminum top cover is equipped with a cathode terminal electrically connected to the cathode tab, an anode terminal electrically connected to the anode tab, an injection hole, and an explosion-proof valve. A tab of a copper plate is electrically connected to the anode terminal to form an outer short-circuit to release energy of the faulty cell and protect the lithium-ion battery when the battery is punctured or crushed or otherwise misused.

As a further improvement of the invention, a copper plate is embedded in the safety bracket, and a tab of the copper plate is electrically connected to the anode terminal.

As a further improvement of the invention, the aluminum housing is electrically connected to the cathode terminal.

As a further improvement of the invention, the safety bracket is a plastic safety bracket. The safety bracket is generated through plastic injection molding, which ensures electric disconnection from the embedded copper plate and the electrode assembly and ensures internal stability.

As a further improvement of the invention, the thickness of the anode terminal is 0.2 mm.

As a further improvement of the invention, the anode terminal extends onto the aluminum housing, and is overlaid with a PET patch. With the anode terminal overlaid with the PET patch, the anode terminal is isolated from the outside and protected.

As a further improvement of the invention, the thickness of the PET patch is 0.1 mm.

Compared with the prior art, this invention achieves the beneficial effects that, a safety protection unit deployed on the bracket can fix the electrode assembly, and in addition, when the battery is misused such as punctured or crushed, release energy of a faulty battery core through an outer short-circuit to avoid greater accidents and ensure safety performance of the battery.

### BRIEF DESCRIPTION OF DRAWINGS

FIG. 1 is a main view of the invention; and

FIG. 2 is a right view of the invention.

### DETAILED DESCRIPTION OF PREFERRED EMBODIMENTS

To make the objectives, technical solutions and advantages of the invention more comprehensible, the following gives more details with reference to accompanying drawings.

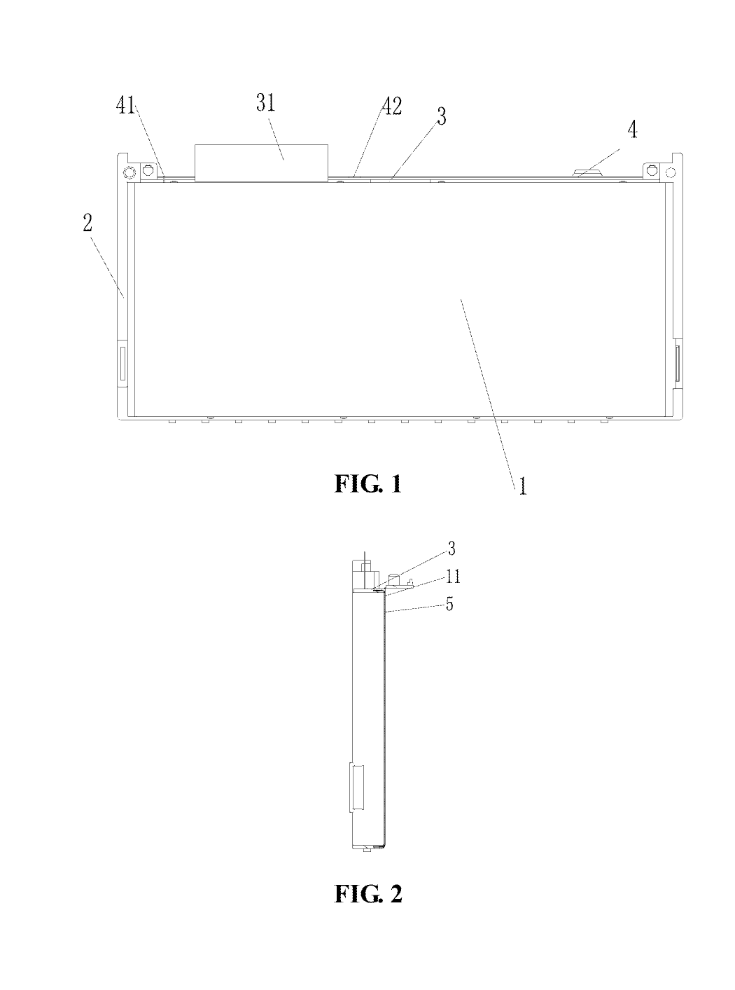

As shown in FIG. 1 and FIG. 2, a lithium-ion battery with a safety protection bracket includes an electrode assembly 1 and an aluminum housing 2 for receiving the electrode assembly 1, where the electrode assembly 1 includes a cathode, an anode, and a separator film; a cathode tab is positioned on the cathode , an anode tab is positioned on the anode, a safety bracket 3 is positioned on the top of the electrode assembly 1, the safety bracket 3 is located between the aluminum housing 2 and the electrode assembly 1, and an aluminum top cover 4 fixedly connected to the aluminum housing 2 is positioned on the aluminum housing 2. The safety bracket 3 positioned in the lithium-ion battery can fix the electrode assembly 1, and in addition, the safety bracket 3 and the lithium-ion battery form an outer short-circuit to release energy of a faulty cell and ensure safety performance of the battery when the battery is punctured or crushed or otherwise misused.

The aluminum top cover 4 is equipped with a cathode terminal electrically connected to the cathode tab, an anode terminal 11 electrically connected to the anode tab, an injection hole 41, and an explosion-proof valve 42.

A copper plate 31 is embedded in the safety bracket 3, and a tab of the copper plate 31 is electrically connected to the anode terminal 11. A tab of a copper plate 31 is electrically connected to the anode terminal to form an outer short-circuit to release energy of the faulty cell and protect the lithium-ion battery when the battery is punctured or crushed or otherwise misused.

The aluminum housing 2 is electrically connected to the cathode terminal.

The safety bracket 3 is a plastic safety bracket. The safety bracket 3 is generated through plastic injection molding, which ensures electric disconnection from the embedded copper plate 31 and the electrode assembly 1 and ensures internal stability.

The thickness of the anode terminal 11 is 0.2 mm.

The anode terminal 11 extends onto the aluminum housing 2, and is overlaid with a PET patch 5. With the anode terminal 11 overlaid with the PET patch 5, the anode terminal 11 is isolated from the outside and protected.

The thickness of the PET patch 5 is 0.1 mm.

In the invention, a safety bracket 3 is positioned on the top of an electrode assembly 1, the safety bracket 3 is located between an aluminum housing 2 and the electrode assembly 1, and takes on a low-resistance state when the circuit is normal, so as to ensure normal operation of the circuit; when short circuit occurs or the current is exceptionally large, the copper plate 31 embedded in the safety bracket 3 is electrically connected to the anode terminal 11 to form an outer short-circuit, which naturally increases impedance and limits the current to a sufficiently small extent, thereby exerting an over-current protection effect, controlling the battery current, and improving safety and reliability of the battery.

According to what is disclosed herein, persons skilled in the field of the invention can make appropriate variations and modifications to the foregoing implementation modes. Therefore, the invention is not limited to the specific embodiments disclosed and described above, and the modifications and variations of the invention shall fall within the protection scope specified in the claims of the invention. In addition, although specific terms are employed herein, the terms are merely for ease of description and do not constitute any limitation on the invention.

What is claimed is:

1. A lithium-ion battery with a safety protection bracket, comprising an electrode assembly (1) and an aluminum housing (2) for receiving the electrode assembly (1), wherein the electrode assembly (1) comprises a cathode, an anode, and a separator film; a cathode tab is positioned on the cathode , an anode tab is positioned on the anode, wherein: a safety bracket (3) is positioned on the top of the electrode assembly (1), and the safety bracket (3) is located between the aluminum housing (2) and the electrode assembly (1), and an aluminum top cover (4) fixedly connected to the aluminum housing (2) is positioned on the aluminum housing (2).

2. The lithium-ion battery with a safety protection bracket according to claim 1, wherein: the aluminum top cover (4) is equipped with a cathode terminal electrically connected to the cathode tab, an anode terminal (11) electrically connected to the anode tab, an injection hole (41), and an explosion-proof valve (42).

3. The lithium-ion battery with a safety protection bracket according to claim 2, wherein: a copper plate (31) is embedded in the safety bracket (3), and a tab of the copper plate (31) is electrically connected to the anode terminal (11).

4. The lithium-ion battery with a safety protection bracket according to claim 2, wherein: the aluminum housing (2) is electrically connected to the cathode terminal.

5. The lithium-ion battery with a safety protection bracket according to claim 1, wherein: the safety bracket (3) is a plastic safety bracket.

6. The lithium-ion battery with a safety protection bracket according to claim 2, wherein:
thickness of the anode terminal (11) is 0.2 mm.

7. The lithium-ion battery with a safety protection bracket according to claim 2, wherein: the anode terminal (11) extends onto the aluminum housing (2), and is overlaid with a PET patch (5).

8. The lithium-ion battery with a safety protection bracket according to claim 7, wherein: thickness of the PET patch (5) is 0.1 mm.
